(19) United States
(12) Patent Application Publication
(10) Pub. No.: US 2015/0343502 A1
(43) Pub. Date: Dec. 3, 2015

(54) ANTI-SOILING, ABRASION RESISTANT CONSTRUCTIONS AND METHODS OF MAKING

(71) Applicant: 3M INNOVATIVE PROPERTIES COMPANY, Saint Paul, MN (US)

(72) Inventors: John C. Clark, Maplewood, MN (US); Vivek Krishnan, St. Paul, MN (US); Christopher B. Walker, JR., St. Paul, MN (US)

(73) Assignee: 3M INNOVATIVE PROPERTIES COMPANY, Saint Paul, MN (US)

(21) Appl. No.: 14/653,566

(22) PCT Filed: Dec. 19, 2013
(86) PCT No.: PCT/US13/76398

§ 371 Date: Jun. 18, 2015

Related U.S. Application Data
(60) Provisional application No. 61/739,763, filed on Dec. 20, 2012.

(51) Int. Cl. B08B 17/06; B05D 3/06

(52) U.S. Cl. CPC B08B 17/06; B05D 3/067

(57) ABSTRACT

Described herein is a construction comprising a microsphere layer comprising a plurality of microspheres wherein the microspheres comprise glass, ceramic, and combinations thereof; a first polymer layer comprising a first polymer, wherein the plurality of microspheres is partially embedded in the first polymer layer; and an undercoat layer therebetween the microsphere layer and first polymer layer, wherein the undercoat layer comprises a plurality of silica nanoparticles. Also disclosed herein are articles comprising the construction and methods of making thereof. In one embodiment, the constructions of the present disclosure have good anti-soiling and abrasion resistant properties.

### TECHNICAL FIELD

A microsphere-coated sheet having a nanoparticle-containing undercoat layer is described.

### DESCRIPTION OF THE FIGURES

FIG. 1 is a cross-sectional view of a construction according to one embodiment of the present disclosure;

FIG. 2 is a cross-sectional view of a construction according to one embodiment of the present disclosure; and

FIG. 3 is a cross-sectional view of a transfer article according to one embodiment of the present disclosure.

### SUMMARY

The present disclosure is directed towards providing a construction having a durable surface with good anti-soiling properties and methods of making such constructions.

In one aspect, a construction is provided comprising: a microsphere layer comprising a plurality of microspheres wherein the microspheres comprise glass, ceramic, and combinations thereof; a first polymer layer comprising a first polymer, wherein the plurality of microspheres is partially embedded in the first polymer layer; and an undercoat layer therebetween the microsphere layer and first polymer layer, wherein the undercoat layer comprises a plurality of silica nanoparticles.

In another aspect, an article is provided comprising a construction comprising a microsphere layer comprising a plurality of microspheres wherein the microspheres comprise glass, ceramic, and combinations thereof; a first polymer layer comprising a first polymer, wherein the plurality of microspheres is partially embedded in the first polymer layer; and an undercoat layer therebetween the microsphere layer and first polymer layer, wherein the undercoat layer comprises a plurality of silica nanoparticles.

In yet another aspect, a method of making construction is provided comprising: embedding a layer of microspheres in a second polymer, wherein the microspheres comprise glass, ceramic, and combinations thereof; contacting the embedded layer of microspheres with a composition comprising silica nanoparticles; treating the composition to form a silica nanoparticle coating; contacting the silica nanoparticle coating with a first polymer; and removing the second polymer to form the construction.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Disclosed herein is a construction, which has an exposed surface having for example, durability (e.g., abrasion resistant) and antisoiling properties. These constructions, in one embodiment, may be applied to substrates to alter the properties of the substrate surface.

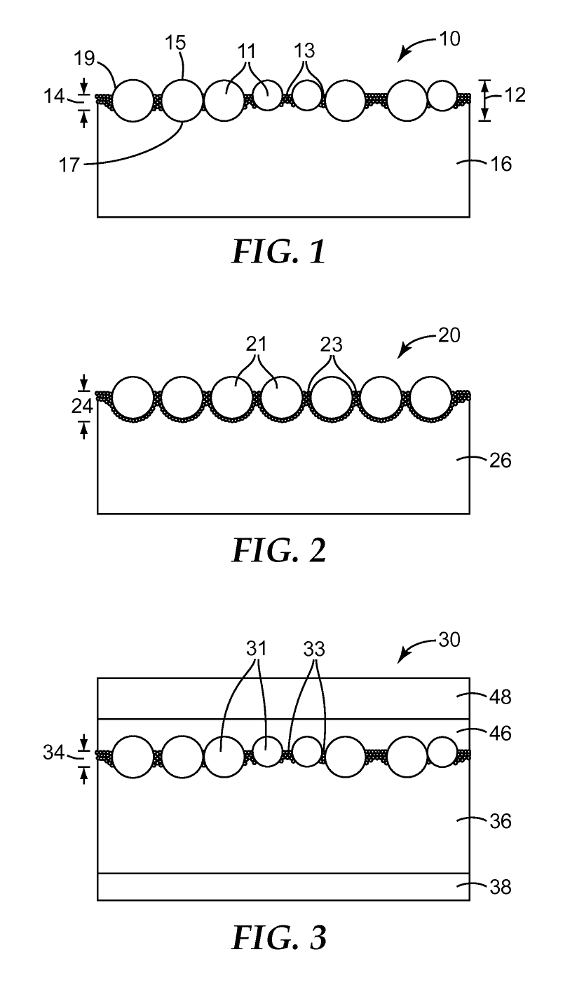

FIG. 1 is an illustration of a cross-section of one embodiment of the construction of the present disclosure. Construction 10 comprises microsphere layer 12 comprising a plurality of microspheres 11, wherein the plurality of microspheres are partially embedded into first polymer layer 16. Undercoat layer 14 is disposed between the plurality of microspheres and first polymer layer 16. Undercoat layer 14 comprises a plurality of silica nanoparticles 13.

The constructions of the present disclosure are made via a transfer method, which may be understood by reference to FIG. 3, which shows transfer article 30. The transfer method employs a carrier, which in its simplest form comprises support layer 48 and second polymer layer 46 bonded thereto. Second polymer layer 46 temporarily partially embeds a plurality of microspheres. Undercoat layer 34 (comprising nanoparticles 33) and then first polymer layer 36 are sequentially constructed upon the partially embedded microspheres 31. Additional layers, such as layer 38 may be optionally contacted to first polymer layer 36. Second polymer layer 46 has low adhesion to the plurality of microspheres as compared to the undercoat and first polymer layers in which the plurality of microspheres are also embedded in, so that the carrier can be removed to expose the surface of the plurality of microspheres, generating the constructions of the present disclosure.

The carrier comprises a support layer and a second polymer layer. As will be described below, the microspheres are first embedded into the second polymer layer of the carrier. Because the second polymer layer generally has a tacky nature, the second polymer layer is typically contacted onto a support layer to provide physical support to the second polymer layer.

Support Layer

The support layer should be “dimensionally stable”. In other words it should not shrink, expand, phase change, etc. during the preparation of the transfer article. Useful support layers may be thermoplastic, non-thermoplastic or thermosetting, for example. One skilled in the art would be able to select a useful film for the article of the present disclosure. If the support layer is a thermoplastic film it should preferably have a melting point above that of the second polymer. Useful temporary support layers for forming the carrier include, but are not limited to those selected from the group consisting of paper and polymeric films such as biaxially oriented polyethylene terephthalate (PET), polypropylene, polymethylpentene and the like which exhibit good temperature stability and tensile so they can undergo processing operations such as bead coating, adhesive coating, drying, printing, and the like.

Second Polymer

Useful release layers for forming the second polymer include but are not limited to thermoplastics such as those selected from the group consisting of polyolefins such as polyethylene, polypropylene, organic waxes, blends thereof, and the like.

The thickness of the second polymer layer is chosen according to the microsphere diameter distribution. According to the present disclosure, the microsphere embedment becomes approximately the mirror image of the carrier embedment. For example, a microsphere which is embedded to about 30% of its diameter in the second polymer layer is typically embedded to about 70% of its diameter in first polymer layer.

In order to partially embed the microspheres in the second polymer layer, the second polymer layer should preferably be in a tacky state (either inherently tacky and/or by heating). The microspheres may be partially embedded, for example, by coating a layer of microspheres on the second polymer layer followed by one of (1)-(3):(1) heating the microsphere coated carrier, (2) applying pressure to the microsphere coated carrier (with, for example, a roller) or (3) heating and applying pressure to the microsphere coated carrier.

For a given second polymer layer, the microsphere embedment process is controlled primarily by temperature, time of heating and thickness of the second polymer layer. The interface of the second polymer layer with the temporary support layer becomes an embedment bonding surface since the microspheres will sink until they are stopped by the dimensionally stable temporary support layer.

The thickness of the second polymer layer should be chosen to prevent encapsulation of most of the smaller diameter microspheres so that they will not be pulled away from the first polymer layer when the second polymer layer is removed. On the other hand, the second polymer layer must be thick enough so that the larger microspheres in the microsphere layer are sufficiently embedded to prevent their loss during subsequent processing operations.

Microsphere Layer

The microsphere layer comprises a plurality of microspheres. The microspheres useful in the present disclosure comprise glass, ceramic, or combinations thereof. Glass is an amorphous material, while ceramic refers to a crystalline or partially crystalline material. Glass ceramics have an amorphous phase and one or more crystalline phases.

These materials are known in the art.

The microspheres may comprise oxide materials including: silicon dioxide, boron oxide, phosphorous oxide, aluminum oxide, germanium oxide, tin oxide, zinc oxide, bismuth oxide, titanium oxide, zirconium oxide, lanthanide oxides, barium oxide, strontium oxide, combinations thereof; and nonoxide materials including carbide, boride, nitride and silicide, and combinations thereof; and combinations of oxide and nonoxide materials.

Exemplary glass types include: soda lime silicate glass, borosilicate, Z-glass, E-glass, titanate- and aluminate-based glasses, etc. Exemplary glass-ceramic microspheres include those based on lithium disilicate.

In some embodiments, a useful range of average microsphere diameters is at least 5, 10, 25, 40, 50, 75, 100, 150, 200 or even 250 μm (micrometers); at most 500, 600, 800, 900, or even 1000 μm. The microspheres may have a unimodal or multi-modal (e.g., a bimodal) size distribution depending on the application.

In one embodiment, the microspheres in the plurality of microspheres are largely spherically shaped.

In one embodiment, the microspheres comprise a surface modification as is known in the art to improve the adhesion to the first polymer layer. Such treatments include those selected from the group consisting of silane coupling agent, titanate, organo-chromium complex, and the like, to maximize their adhesion to the first polymer layer. Preferably, the coupling agent is a silane such as aminosilane, glyoxide silane, or acrylsilane.

The treatment level for such coupling agents is on the order of 50 to 500 parts by weight coupling agent per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the coupling agent with the microsphere, followed by drying in a tumbler or auger-fed dryer to prevent the microspheres from sticking together. One skilled in the art would be able to determine how to best treat the microspheres with the coupling agent.

The microspheres useful in the present disclosure may be transparent, translucent, or opaque. In one embodiment, the microspheres have a refractive index of at least 1.4, 1.6, 1.8, 2.0 or even 2.2. In another embodiment, the microspheres have a refractive index of less than 1.3.

The microspheres are contacted with the second polymer layer of the carrier and using either heat and/or pressure, the plurality of microspheres are embedded into the second polymer layer. A monolayer of the microspheres is embedded into the surface of the second polymer layer, meaning that there is minimal stacking of the microspheres and that each bead is in contact with the first polymer layer and/or the undercoat layer. In one embodiment, the plurality of microspheres may not be closest packed on the surface of the second polymer, resulting in a surface area coverage less than 100% of the major surface of the second layer.

Undercoat Layer

The undercoat layer of the present disclosure comprises a plurality of nanoparticles. It is this plurality of nanoparticles, which provides the antisoiling characteristics of the present disclosure.

The nanoparticles of the present disclosure comprise silicon dioxide. The nanoparticles may comprise small amounts of stabilizing ions such as ammonium and alkaline metal ions, or it may be a combination of metal oxides such as a combination of silica and zirconia.

The inorganic nanoparticles as used herein may be distinguished from materials such as fumed silica, pyrogenic silica, precipitated silica, etc. Such silica materials are known to those of skill in the art as being comprised of primary particles that are essentially irreversibly bonded together in the form of aggregates, in the absence of high-shear mixing. These silica materials have an average size greater than 100 nm (e.g., typically of at least 200 nanometers) and from which it is not possible to straightforwardly extract individual primary particles.

The silica nanoparticles used in the present disclosure composition have average primary particle diameter of at least 1, 2, 3, 4, 5, 6, 8, 10, 20, 40, or even 50 nm (nanometers) and at most 150, 200, 250, 300, 400, or even 500 nm.

In one embodiment, the silica nanoparticles are not surface modified. In another embodiment, the silica nanoparticle are surface modified as known in the art. For example, silica-based nanoparticles can be treated with monohydric alcohols (e.g., a saturated primary alcohol), polyols, or mixtures thereof under conditions such that silanol groups on the surface of the nanoparticles chemically bond with hydroxyl groups to produce surface-bonded ester groups. The surface of silica nanoparticles can also be treated with organosilanes, e.g, alkyl chlorosilanes, trialkoxy arylsilanes, olefinic silanes, or trialkoxy alkylsilanes, (meth)acryloxypropyl trialkoxy silanes, (3-glycidoxy propyl) trialkoxy silanes, or with other chemical compounds, e.g., organotitanates, which are capable of attaching to the surface of the nanoparticles by a chemical bond (covalent or ionic) or by a strong physical bond, and which are water dispersable. Silica-based (and zirconia-based) nanoparticles may be treated with a phase compatibilizing surface treatment agent.

In some embodiments, uncured nanoparticles may result in a weak interface between the liner and the microspheres such that microsphere transfer to the polymer layer during liner removal is inhibited and/or the uncured nanoparticles may slough particles overtime. Therefore, in one embodiment, the nanoparticles are cured to cross-link the nanoparticles together and/or with the polymer, creating a crosslinked network. The nanoparticles may be thermally curable or UV-curable. In UV-curable embodiments, a composition comprising the UV-curable nanoparticles along with a solvent and an UV initiator, and optionally (meth)acrylate resins, are applied to the surface, the solvent is evaporated and the particles are UV-cured using any of the common sources of actinic radiation known in the coating industry. Preferred sources of UV irradiation are the medium pressure mercury bulbs that emit in the UV C region, and numerous vendors of belt driven UV processors exist, of which Fusion Systems (Gaithersburg Minn.) and Heraeus are notable. Free radical photoinitiators absorb the UV radiation, resulting in fragmentation into free radicals, which initiate the free radical polymerization and crosslinking pathways. For cationic polymerizations, onium salts are preferred and fragment to generate acid species that begin ring opening polymerizations (e.g. epoxy reactions) upon exposure to UV radiation.

The undercoat layer may be formed into a porous silica coating using the method as disclosed in U.S. Publ. No. 2011-0033694 (Jing et al.), herein incorporated by reference. Briefly, an aqueous dispersion of silica nanoparticles is acidified to form a porous nanoparticle coating. The aqueous dispersion of silica nanoparticles, having a pH of less than 5, and comprising an acid having a pKa of <3.5 is applied to the microsphere layer and the dispersion is dried to form a silica nanoparticle coating. Acids such as oxalic acid, citric acid, H₂SO₃, H₃PO₄, CF₃CO₂H, HCl, HBr, HI, HBrO₃, HNO₃, HClO₄, H₂SO₄, CH₃SO₃H, CF₃SO₃H, CF₃CO₂H, and CH₃SO₂OH may be used to adjust the pH of the composition. In one embodiment the aqueous dispersion comprises (a) 0.5 to 99 wt % water, (b) 0.1 to 20 wt % silica nanoparticles having an average particle diameter of 40 nm or less, (c) 0 to 20 wt % silica nanoparticles having an average particle diameter of 50 nm or more, wherein the sum of (b) and (c) is 0.1 to 20 wt %, (d) a sufficient amount of an acid having a pKa of <3.5 to reduce the pH to less than 5, and (e) 0 to 20 wt % of a tetraalkoxysilane, relative to the amount of the silica nanoparticles. The undercoat layer made using this process is a continuous network of silica nanoparticles agglomerates. The particles preferably have an average primary particle size of 40 nanometers or less, where the term “continuous” refers to covering the surface with virtually no discontinuities or gaps in the areas where the gelled network is applied and the term “network” refers to an aggregation or agglomeration of nanoparticles linked together to form a porous three-dimensional network. The “primary particle size” refers to the average size of unagglomerated single particles of silica.

In another embodiment, the undercoat layer may be polymer coating comprising silica using the method as disclosed in U.S. Pat. No. 5,073,404 (Huang) herein incorporated by reference. Briefly, an aqueous dispersion comprising a polymer is mixed with silica nanoparticles (e.g., a silica sol) which can then be applied to the plurality of microspheres and then cured (via heat or light) to form the undercoat layer. Exemplary polymers include: aliphatic polyurethanes, polyvinylchloride copolymers having a minor portion (i.e. less than 15 weight percent) of a comonomer containing at least one carboxylic acid or hydroxyl moiety, and acrylic polymers having a glass transition temperature (Tg) of −20° C. to 60° C.

In one embodiment, the undercoat layer is substantially uniform in thickness, meaning that the undercoat layer has approximately the same thickness across the construction. The thickness may be at least 250 nm, 500 nm, or even 750 nm in thickness. Generally, the thickness of the undercoat layer is thin enough to enable the microspheres to be embedded into the first polymer layer.

In another embodiment, the undercoat layer may be formed by coating a composition comprising surface modified nanoparticles, an organic solvent, and a photoinitiator onto a microsphere layer, drying/evaporating the solvent away, then UV curing and crosslinking the composition comprising the surface modified nanoparticles.

First Polymer Layer

The first polymer layer is not particularly limited. In one embodiment, the first polymer layer may be a reactive polymer substrate enabling the first polymer layer to be disposed upon another substrate. Exemplary first polymer layers include: a polyurethane, polyesters, acrylic and methacrylic acid ester polymers and copolymers, epoxies, polyvinyl chloride polymers and copolymers, polyvinyl acetate polymer and copolymers, polyamide polymers and copolymers, fluorine containing polymers and copolymers such as fluorourethanes, fluoroacrylates, and fluoroolefin containing polymers and copolymers (e.g., comprising tetrafluoroethylene, hexafluoropropylene, vinylidene fluoride monomeric units, etc.), silicone containing copolymers, a urethane/(meth)acrylate, elastomers, such as neoprene, acrylonitrile butadiene copolymers, and compatible blends thereof.

The first polymer layer can be formed, for example, out of solution, aqueous dispersion, or 100% solids coating such as via hot melt or extrusion. Exemplary first polymer layers include aliphatic polyurethane aqueous dispersions and blends thereof with aqueous acrylic polymers and copolymers, thermoplastic polyamides and copolymers and vinyl plastisols and organosols. In one embodiment, aqueous aliphatic polyurethane dispersions may be used as the first polymer layer because of their excellent solvent resistance, resistance to weathering, and the ease with which they may be cleaned. The first polymer layer can be formed for example by a solvent coating of a polymer or polymer forming mixture, such as a two part urethane.

The first polymer layer may be transparent, translucent, or opaque. It may be colored or colorless. The first polymer layer may, for example, be clear and colorless or pigmented with opaque, transparent, or translucent dyes and/or pigments.

Because the microspheres are embedded into the first polymer layer, first polymer layer must be sufficiently thick to enable the partial embedding of the microspheres. As used herein “embedded” means that if the microsphere was removed from the first polymer layer, an impression (or contour) of the microsphere would remain in the first polymer layer where the microsphere was located. Generally, the first polymer layer has a thickness of at least 50% of the average diameter of the microspheres. For example, 10, 25, 50, 100, or even 250 μm (micrometers) or even more (e.g., at least 1 millimeter, at least 1 centimeter, or even 1 meter).

In the present disclosure, the microspheres are partially embedded into the surface of the first polymer such the microspheres are embedded enough to create a sufficient adhesion between the first polymer and the microsphere (so that the microspheres do not easily come off the surface). Typically this means that at least 40%, 50%, 60%, or even 70% of the average diameter of each microsphere is embedded into the first polymer layer and at most 85 or even 90% of the average diameter of each microsphere is embedded into the first polymer layer.

The first polymer layer is an organic polymeric material. It should exhibit good adhesion to the microspheres. A coupling agent for the microspheres could be added directly to the first polymer layer or disposing the coupling agent directly on the microsphere surfaces. It is important that the coupling agent have sufficient release from the second polymer layer to allow removal of the carrier from the microspheres which are embedded on one side in the first polymer and undercoat layer and on the other side in the second polymer layer.

The first polymer layer is typically formed on the carrier after the microspheres have been partially embedded in the second polymer layer. The first polymer layer is typically coated over the partially embedded microspheres and undercoat layer by a direct coating process, but could also be provided over the microspheres and undercoat layer via thermal lamination either from a separate carrier or by first forming the first polymer layer on a separate substrate from which it is subsequently transferred to cover the microspheres and undercoat layer.

Optional Layer(s)

The construction and transfer article of the present disclosure may each optionally further comprise one or more layers, shown for example, as layer 38 in FIG. 3, which is disposed on first polymer layer 36. For example, the construction of the present disclosure may function as a surface protection or decoration for an article. The first polymer layer of the construction may be adhered to another substrate such as metal; paint coated metal; paper; glass and carbon fiber; fabrics (including synthetics, non-synthetics, woven and non-woven such as nylon, polyester, etc.); polymer coated fabrics such as vinyl coated fabrics; polyurethane coated fabrics; leather; etc. An adhesive layer, may optionally be included in order to provide a means for bonding the first polymer layer of the construction to a substrate. These optional adhesive layer(s) may be optionally present when, for example, the first polymer layer cannot function also as an adhesive for a desired substrate. A substrate adhesive layer (as well as any other optional adhesive layers) may comprise the same general types of polymeric materials used for the first polymer layer and may be applied following the same general procedures. However, each adhesive layer used must be selected such that it will adhere the desired layers together. For example, a substrate adhesive layer must be selected such that it can adhere to an intended substrate as well as to the other layer to which it is bonded. Optional reinforcing layers may also be included in the construction and the transfer article of the present disclosure to, for example, enhance the ability to separate the carrier from the microsphere layer.

Constructions

The present disclosure may be further understood with respect to FIGS. 1 and 2.

FIGS. 1 and 2 represent embodiments of constructions of the present disclosure, they are not drawn to scale, but instead used to represent particular features of the present disclosure.

The plurality of microspheres are embedded into the first polymer layer, which means that the microspheres are located approximately at least 40%, 50%, 60%, 70% or even 80% of the microsphere diameter into the first polymer layer.

The microsphere layer may be discontinuous or continuous across the surface of the construction. For example, as shown in FIG. 1, the plurality of microspheres is discontinuous across the surface of construction 10, where some microspheres touch their neighbor and others do not. Because the plurality of microspheres provide for example, durability, the surface area coverage of the plurality of microspheres should be more than 30%, 40%, 50%, 60%, 70%, 80%, or even 90% of the major surface of the construction of the present disclosure.

In the present disclosure, the microspheres are at least partially embedded into the first polymer layer so that a portion of each of the microspheres projects outwardly from the surface of the construction once the carrier is removed. In the constructions of the present disclosure, each microsphere comprises an exposed apex 15 and an opposing embedded apex 17 as depicted in FIG. 1, where surface 19 is the exposed surface of the construction. As shown in FIG. 1, which comprises two different diameters of microspheres, the exposed apex of each of the microspheres in the plurality of microspheres is less than 35, 30, 25, 20, 15, 10, or even 5 micrometers different in height.

In one embodiment, the construction of the present disclosure is substantially free of a coating. In other words, there is no additionally layer on the microsphere layer of the construction, opposite the undercoat layer.

Because of how the constructions of the present disclosure are made, i.e., via a transfer process wherein a portion of the microspheres are embedded in the second polymer layer to which the undercoat layer is formed thereon, the portion of the microspheres which were temporarily embedded in the second polymer layer should not comprise nanoparticles, thus, the exposed microsphere surface of the construction of the present disclosure should be substantially free of nanoparticles.

As used herein the “undercoat” layer means, that at least some portion of the undercoat layer (e.g., a silica nanoparticle) is under the microsphere on the side of the first polymer layer when viewed in a cross-section. The undercoat layer may be continuous as shown in FIG. 2 or discontinuous as shown in FIG. 1, where FIG. 2 depicts construction 20, comprising a plurality of microspheres 21, an undercoat layer 24 comprising silica nanoparticles 23 and a first polymer layer 26. The undercoat layer comprises silica nanoparticles and generally has a thickness of at least 250 nm, meaning that the undercoat layer at least in some regions comprises more than a monolayer of silica nanoparticles.

In one embodiment, the undercoat layer is porous, which advantageously may allow the first polymer layer to permeate the interface between the undercoat layer and the first polymer layer, thereby improving the adhesion between the two materials. However, the undercoat layer is a separate layer from the first polymer layer and there should be no first polymer located at the exposed surface of the construction.

Described below are various exemplary embodiments of the present disclosure:

### Embodiment 1

A construction comprising: a microsphere layer comprising a plurality of microspheres wherein the microspheres comprise glass, ceramic, and combinations thereof; a first polymer layer comprising a first polymer, wherein the plurality of microspheres is partially embedded in the first polymer layer; and an undercoat layer therebetween the microsphere layer and first polymer layer, wherein the undercoat layer comprises a plurality of silica nanoparticles.

### Embodiment 2

The construction of embodiment 1, wherein the first polymer is selected from at least one of: a polyurethane, polyesters, (meth)acrylic acid ester polymers, an epoxy, a (meth)acrylate, polyvinylchloride polymer, polyvinyl acetate polymer, polyamides, a urethane/(meth)acrylate, a silicone, polyolefin, acrylobutadiene polymers, fluoropolymers, and blends thereof.

### Embodiment 3

The construction of any one of the previous embodiments, wherein the silica nanoparticles are UV-curable.

### Embodiment 4

The construction of any one of the previous embodiments, wherein the microsphere layer comprises a monolayer of microspheres.

### Embodiment 5

The construction of any one of the previous embodiments, wherein the microspheres in the plurality of microspheres have an average diameter of 10 to 1000 micrometers.

### Embodiment 6

The construction of any one of the previous embodiments, wherein each microsphere comprises an exposed apex and an opposing embedded apex, wherein the exposed apex of each of the microspheres is less than 35 micrometers different in height.

### Embodiment 7

The construction of any one of the previous embodiments, wherein the construction comprises an exposed surface, wherein the exposed surface is substantially free of a coating.

### Embodiment 8

The construction of any one of the previous embodiments, wherein the silica nanoparticles in the plurality silica nanoparticles have an average primary particle size of 200 nm or less.

### Embodiment 9

The construction of any one of the previous embodiments, wherein the undercoat layer is substantially uniform in thickness.

### Embodiment 10

The construction of any one of the previous embodiments, wherein the undercoat layer is discontinuous.

### Embodiment 11

An article comprising the construction of any one of the previous embodiments.

### Embodiment 12

A method of making a construction comprising:
(a) embedding a layer of microspheres in a second polymer, wherein the microspheres comprise glass, ceramic, and combinations thereof;
(b) contacting the embedded layer of microspheres with a composition comprising silica nanoparticles;
(c) treating the composition to form a silica nanoparticle coating;
(d) contacting the silica nanoparticle coating with a first polymer; and
(e) removing the second polymer to form the construction.

### Embodiment 13

The method of embodiment 12, wherein the first polymer is selected from at least one of: a polyurethane, polyesters, (meth)acrylic acid ester polymers, an epoxy, a (meth)acrylate, polyvinylchloride polymer, polyvinyl acetate polymer, polyamides, a urethane/(meth)acrylate, a silicone, a polyolefin, a fluoropolymer, acrylobutadiene polymers, and blends thereof.

### Embodiment 14

The method of any one of embodiments 12-13, wherein the second polymer is selected from at least one of a polyolefin, organic wax, and combinations thereof.

### Embodiment 15

The method of any one of embodiments 12-14, wherein the microspheres in the plurality of microspheres have an average diameter of 10 to 1000 micrometers.

### Embodiment 16

The method of any one of embodiments 12-15, the silica nanoparticles have an average primary particle size of 200 nm or less.

### Embodiment 17

The method of any one of embodiments 12-16, wherein the composition comprises an aqueous dispersion of silica nanoparticles; having a pH of less than 5, and an acid having a pKa of <3.5.

### Embodiment 18

The method of embodiment 17, wherein the concentration of silica nanoparticles in the composition is 0.1 to 20 wt %.

### Embodiment 19

The method of any one of embodiments 17-18, wherein the composition comprises: (a) 0.5 to 99 wt % water; (b) 0.1 to 20 wt % silica nanoparticles having an average particle diameter of 40 nm or less; (c) 0 to 20 wt % silica nanoparticles having an average particle diameter of 50 nm or more, wherein the sum of (b) and (c) is 0.1 to 20 wt %; (d) a sufficient amount of an acid having a pKa of <3.5 to reduce the pH to less than 5; and (e) 0 to 20 wt % of a tetraalkoxysilane, relative to the amount of the silica nanoparticles.

### Embodiment 20

The method of embodiment 19, comprising the steps of adding sufficient acids to adjust the pH of the composition to less than 5, then adding sufficient base to adjust the pH to the range of 5 to 6.

### Embodiment 21

The method of any one of embodiments 12-20, wherein the silica nanoparticles are UV-curable.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

### Materials

| Designation | Description |
|---|---|
| K-FLEX 188 | 100% Active polyester polyol obtained from King |
| | Industries, Inc., Norwalk, CT. |
| DESMODUR | Solvent free polyfunctional aliphatic isocyanate resin |
| N3300A | based on hexamethylenediisocyanate, obtained from |
| | Bayer Materials Science, Pittsburgh, PA. |
| DBTDL T-12 | Di-butyltin dilaurate catalyst, obtained from Air Products |
| | and Chemicals, Inc., Allentown, PA under trade |
| | designation DABCO T-12. |
| Microspheres I | Soda lime silicate glass microspheres (40-55 microns) |
| | obtained from Swarco Inc., Austria. |
| NALCO 1115 | Colloidal silica dispersion obtained from Nalco |
| | Company, Naperville, IL, under the trade |
| | designation NALCO 1115 COLLOIDAL SILICA. |
| DVSZN004 | Amorphous silica dispersion obtained from Nalco |
| | Company under the trade designation, NALCO |
| | DVNZ004 CATALYST SUPPORT. |
| Surface- | Surface modified nanoparticles having pendent |
| modified silica | methacrylate groups prepared as disclosed in |
| nanoparticles | U.S. Pat. No. 7,615,283 col. 25. |
| MEK | Methyl ethyl ketone |
| Irgacure 651 | 2,2-Dimethoxy-1,2-diphenylethan-1-one, obtained from |
| | BASF, Ludwigshafen, under the trade designation |
| | “IRGACURE 651”. |
| GK570 | A 65% solids solution in n-butyl acetate of a copolymer |
| | of tetrafluoroethylene and vinyl monomers, having a |
| | hydroxyl value of 55-65 mg KOH/gram resin which is |
| | suitable for reaction with isocyanates, available under the |
| | trade designation “ZEFFLE GK 570” from Daikin |
| | America, Orangeburg, NY. This is believed to contain |
| | 35-40% fluorine by weight. |
| Silco 3530k | Colloidal silica dispersion obtained from Silco, under the |
| | trade designation Silco EM-3530K. |
| Fluoropolymer | A fluorinated polymer available under the trade |
| | designation “3M DYNAMAR POLYMER |
| | PROCESSING ADDITIVE FX 5912” from 3M |
| | Company, St. Paul, MN as a solution in a 50/50 |
| | mixture of MEK (methyl ethyl ketone) and MIBK |
| | (methyl isobutyl ketone) at a total solids of 20%. |
| Microspheres II | borosilicate glass microspheres (38-75 microns) obtained |
| | from MoSci. Inc., Rolla, Missouri. |

Method for Making Microsphere Articles and Transfer Articles

To make the transfer article, a polyethylene coated polyester substrate was heated to a temperature of about 140° C. to soften and make its surface tacky. Microspheres I were sprinkled over the polyethylene coated side of the heated polyester substrate forming a monolayer coating of microspheres (on the polyethylene coated side of the polyester substrate). The microspheres I were partially embedded in the polyethylene coating layer to a depth equivalent to about 30-40% of their diameter. The degree to which the microspheres were embedded in the polyethylene layer could be controlled by varying the temperature and the heating time of the polyethylene coated polyester substrate.

A silica nanoparticle coating composition was prepared by mixing NALCO 1115 and DVSZN004 at a 70:30 weight ratio. The coating composition had a solids content of about 5 weight % and the pH of the composition was adjusted to about 2 using diluted HNO₃.

The resulting composition was coated over the above prepared polyethylene coated polyester substrate with the embedded microspheres using BYK-GARDNER U-BAR5334 obtained from BYK-Gardner, Columbia, Md. to form a consistent and uniform coating. Coatings having wet thickness of 50 μm, 100 μm, and 150 μm (2 mils, 4 mils, and 6 mils, respectively), which corresponded to dry thickness of about 100 nm, 200 nm, 300 nm, respectively, were prepared. The silica nanoparticle coated articles were first air dried and then heated to 80° C. for 45 minutes to remove any leftover water and sinter the silica nanoparticles.

Polyurethane (PU) binder compositions were prepared by mixing desired amounts of K-FLEX 188 and DESMODUR N 3300A to which DBTDL T-12 (300 ppm added based on total solids) was added. The polyurethane binder composition was varied by changing the ratio of K-FLEX 188 and DESMODUR N 3300A to prepare binder compositions having polyurethane (PU) indexes of 0.8, 0.95, and 1.05.

The resulting polyurethane composition with the desired PU index was then coated onto the above prepared transfer article over the silica nanoparticle layer (i.e., the undercoat layer) and allowed to cure at 70° C. for 1 hour. The polyurethane coating was about 125 μm (5 mils) thick. Samples were removed from the oven and the polyester substrate was peeled off to form and expose the microsphere article.

When the above polyurethane system was coated onto a release liner (instead of the transfer article prepared above) and cured at 70° C. for 1 hour, a polyurethane film without the microspheres and the silica nanoparticle undercoat layer was formed.

Method for Measuring Color and Luminosity

Color and luminosity (Hunter L,a,b values) of the microsphere articles prepared as described above were determined using a spectrophotometer (such as one commercially available under the trade designation “HunterLab MiniEZ”, obtained from Hunter Associates Labs Inc., Reston Va.) under conditions of 45/0 directional illumination. Samples were also examined visually (by naked eye) and perceived color was noted.

The color and luminosity of the microsphere articles of examples and comparative examples described below was measured using the above method twice: before and after the microsphere articles were subjected to a dirt test described below. In this manner an initial Hunter L, a, b values (i.e, before the dirt test), a final Hunter L, a, b values (i.e., after the dirt test) were determined for each sample. Then using difference of the initial and final Hunter L, a, b data, Hunter ΔL, Δa Δb values were calculated. Finally, the ΔE of each sample was calculated using the formula ΔE=√(ΔL²+Δa²+Δb²) and reported. Generally, the higher the ΔE, the more dirt the sample has accumulated.

Method for Dirt Test

For this test, test specimens prepared in Examples and Comparative Examples described below were cut round samples using a Mark IV AccuCut button maker and an 87 mm circle die obtained from AccuCut Craft, Fremont, Nebr. The specimens were weighed and their initial weights were recorded using a CAHN 315 microbalance obtained from Thermo Cahn, Newington, N.H. Then, the specimens were placed in a glass jar that was filled with 10 grams of Arizona dirt with a particle size of 0-70 μm, obtained from Powder Technology, Inc. Burnsville, Minn., one at a time. The glass jar and its content were shaken for 60 seconds in a random motion to ensure dust and the surfaces of the specimens came in contact. Afterwards, the specimens were weighed again and their final weights were recorded. The difference between the final and initial weight of the samples were ascribed to the amount of dirt picked up and was reported as Amass in grams per squared meters (g/m²).

### Comparative Example 1

### CE1

CE1 articles were polyurethane films prepared by coating the polyurethane binder compositions described above on a release liner and curing at 70° C. for 1 hour. The resulting polyurethane films (having a PU index of 0.8, 0.95 and 1.05) did not have the microspheres and the silica nanoparticle undercoat layer. The CE1 articles were tested using the methods described above for dirt test and color and luminosity measurement.

### Comparative Example 2

### CE2

CE2 microsphere article and transfer articles were prepared as described above according to the method for making microsphere articles and transfer articles except that for CE2 microsphere articles no silica nanoparticle undercoat layer was applied. CE2 microsphere article and transfer articles were prepared using polyurethane compositions having PU index of 0.8, 0.95 and 1.05. The CE2 microsphere articles were tested using the methods described above for dirt test and color and luminosity measurement.

### Examples 1-3

### EX1-EX3

EX1-EX3 microsphere article and transfer articles were prepared as described above according to the method for making microsphere articles and transfer articles. For EX1-EX3 microsphere articles the thickness of the silica nanoparticle undercoat layer was varied: The wet thickness of the silica nanoparticle undercoat layer was 50 μm (2 mils) for EX1, 100 μm (4 mils) for EX2, and 150 μm (6 mils) for EX3. The corresponding dry thickness of the silica nanoparticle undercoat layer was 1.25 microns for EX1 2.5 microns for EX2, and 3.75 microns for EX3. EX1-EX3 microsphere articles were prepared using polyurethane compositions having PU index of 0.8, 0.95 and 1.05. EX1-EX3 microsphere articles were tested using the methods described above for dirt test and color and luminosity measurement.

### Example 4

### EX4

EX4 was same as EX3 except that polyethylene coated polyester substrate with the embedded microspheres was plasma treated with air plasma before the nanosilica composition was coated. The plasma treatment of the polyethylene coated polyester substrate with the embedded microspheres was accomplished using a Harrick PDC-32G plasma treater (obtained from Harrick Scientific Corp., Ossining, N.Y.) equipped with a precision rotary vacuum pump (Model D25, obtained from Precision Scientific, Chennai, India) at the highest setting for 5 minutes.

EX4 microsphere article was prepared using polyurethane compositions having PU index of 0.95. EX4 microsphere articles were tested using the methods described above for dirt test and color and luminosity measurement.

### Example 5

### EX5

EX5 microsphere article was prepared as in EX3 except that the wet thickness of the nanoparticle coating was 250 microns (10 mil) resulting in a dry coating thickness of about 6.25 microns.

### Example 6

### EX6

EX6 microsphere article was prepared as in EX1 with the following changes: Microspheres II were used instead of Microspheres; the silica nanoparticle coating composition was prepared with 20% Nalco 1115 and 80% Silco 3530 k in water with a solids content of about 4.5 weight % and a pH of 2.5; the polyurethane coating was about 175 μm thick with a 0.95 index, and a white PET (polyethylene terephthalate) reinforcing layer was added, which contacted the polyurethane layer opposite the beads.

### Example 7

### EX7

EX7 microsphere article was prepared as in EX6 except that a layer of Fluoropolymer was cast onto the silica nanoparticle coated article at a wet thickness of 50 μm using a coating square and heating to 70° C. for 30 minutes to dry the film. Then the polyurethane binder composition was added and cured as in EX6.

### Example 8

### EX8

EX8 microsphere article was prepared as in EX7 except that the layer of Fluoropolymer had a wet thickness of 250 μm.

### Example 9

### EX9

10.0 gram of a 40% solids solution of 20 nm of Surface-modified silica nanoparticles were placed in a 100 ml clear glass jar and diluted with 46 g MEK over 2 minutes with manual swirling of the jar, followed by the addition of 0.09 g Irgacure 651. The solution was mixed briefly until homogeneous. The mixture was coated onto a polyethylene coated polyester substrate with embedded microspheres of Microspheres II using a coating square with a 3 mil (76 μm) gap. The silica nanoparticle coated article was air dried at ambient for 20 minutes, the dried for 30 minutes in a batch oven at 80° C. The resulting construction was UV cured with an H bulb mercury lamp UV irradiation in air using a model HP-6 UV Lamp System (including a VPS-3 power supply, a I-6B irradiator, and a conveyer belt) from Fusion UV Systems, Incorporated, Gaithersburg, Md., set at 100% power and a line speed of 50 feet/minute. The nanoparticle coated article was passed through the curing chamber to provide the following total doses: UVA=880 mJ/cm²; UVB=1372 mJ/cm²; UVC=229 mJ/cm²; and UVV=1594 mJ/cm².

A fluorourethane binder composition was prepared by combining and mixing the following components in a cup using a centrifugal resin mixer (MAX 40 mixing cup and FlackTek Speedmixer DAC 150 FV; both from FlackTec Incorporated, Landrum, S.C.) at 2500 rpm for 30 seconds: 2.02 grams DESMODUR N3300, 14.92 grams GK 570, and 3.5 microliters of DBTDL T-12 (300 ppm). The approximate ratio of equivalents isocyanate to equivalents hydroxyl was 1.0:1.0.

The fluorourethane binder composition was then coated onto the above prepared transfer article over the cured nanoparticle layer (i.e., the undercoat layer) using a notch bar coater with a gap setting of 0.002 inches (50 μm). The resulting construction was air dried for one hour then cured in a 80° C. forced air oven for one hour.

The fluorourethane coated construction was then coated with a urethane binder composition. The urethane binder composition with 100% solids was made by combining and mixing 10.02 grams DESMODUR N3300A, 13.03 grams K-FLEX 188, and 7.0 microliters of DBTDL T-12 (300 ppm) in a FlackTek speedmixer as described above. The approximate ratio of equivalents isocyanate to equivalents hydroxyl was 0.97.

The urethane binder composition was then coated onto the fluorourethane side of the fluorourethane coated construction described above using a notch bar coater with at a gap setting of 0.002 inches (25.4 mm) The resulting twice coated construction was cured in a 80° C. forced air oven for one hour.

A free-standing bead film having a white polyester substrate, a layer of 2 part urethane, layer of fluorourethane, a layer of UV cured nanoparticles with microsphere beads embedded in the nanoparticle and fluorourethane was obtained by removal of the transfer carrier.

The Table 1, below summarizes the properties of CE1 articles and CE2, EX1-EX9 microsphere articles as well as the Amass and ΔE data obtained for each of CE1, CE2, and EX1-EX9.

TABLE 1

| | | | Undercoat | | | |
|---|---|---|---|---|---|---|
| | | Nanosilica | layer wet | | | |
| Exam- | Micro- | undercoat | thickness | PU | Δmass | |
| ple | spheres | layer | (μm) | Index | (g/m²) | ΔE |
| CE1 | None | None | 0 | 0.80 | 0.1432 | 2.20 |
| | | | | 0.95 | 0.1286 | 1.35 |
| | | | | 1.05 | 0.1341 | 1.67 |
| CE2 | Yes | None | 0 | 0.80 | 0.8150 | 8.71 |
| | | | | 0.95 | 0.8441 | 9.04 |
| | | | | 1.05 | 1.0377 | 10.47 |
| EX1 | Yes | Yes | 50 | 0.80 | 1.1509 | 10.08 |
| | | | | 0.95 | 1.1832 | 11.13 |
| | | | | 1.05 | 1.2532 | 11.76 |
| EX2 | Yes | Yes | 100 | 0.80 | 0.6577 | 7.35 |
| | | | | 0.95 | 0.8091 | 8.79 |
| | | | | 1.05 | 0.9814 | 11.00 |
| EX3 | Yes | Yes | 150 | 0.80 | 0.5368 | 5.66 |
| | | | | 0.95 | 0.6164 | 7.68 |
| | | | | 1.05 | 0.7405 | 7.61 |
| EX4 | Yes | Yes | 150 | 0.95 | 0.6509 | 8.89 |
| EX5 | Yes | Yes | 250 | 0.95 | 0.439 | 5.97 |
| EX6 | Yes | Yes | 50 | 0.95 | 1.845 | 17.42 |
| EX7 | Yes | Yes | 50 | 0.95 | 0.891 | 10.31 |
| EX8 | Yes | Yes | 50 | 0.95 | 1.190 | 14.41 |
| EX9 | Yes | Yes | 75 | 0.97 | 0.874 | 12.59 |

Foreseeable modifications and alterations of this invention will be apparent to those skilled in the art without departing from the scope and spirit of this invention. This invention should not be restricted to the embodiments that are set forth in this application for illustrative purposes. To the extent that there is a conflict or discrepancy between this specification and the disclosure in any document incorporated by reference herein, this specification will control.

1. A construction comprising:
a microsphere layer comprising a plurality of microspheres wherein the microspheres comprise glass, ceramic, and combinations thereof;
a first polymer layer comprising a first polymer, wherein the plurality of microspheres is partially embedded in the first polymer layer; and
an undercoat layer therebetween the microsphere layer and first polymer layer, wherein the undercoat layer comprises a plurality of silica nanoparticles.

2. The construction of claim 1, wherein the first polymer is selected from at least one of: a polyurethane, polyesters, (meth)acrylic acid ester polymers, an epoxy, a (meth)acrylate, polyvinylchloride polymer, polyvinyl acetate polymer, polyamides, a urethane/(meth)acrylate, a silicone, polyolefin, acrylobutadiene polymers, fluoropolymers, and blends thereof.

3. The construction of claim 1, wherein the plurality of silica nanoparticles are UV-curable.

4. The construction of claim 1, wherein the microsphere layer comprises a monolayer of microspheres.

5. The construction of claim 1, wherein the microspheres in the plurality of microspheres have an average diameter of 10 to 1000 micrometers.

6. The construction of claim 1, wherein each microsphere comprises an exposed apex and an opposing embedded apex, wherein the exposed apex of each of the microspheres is less than 35 micrometers different in height.

7. The construction of claim 1, wherein the construction comprises an exposed surface, wherein the exposed surface is substantially free of a coating.

8. An article comprising the construction of claim 1.

9. A method of making a construction comprising:
embedding a layer of microspheres in a second polymer, wherein the microspheres comprise glass, ceramic, and combinations thereof;
contacting the embedded layer of microspheres with a composition comprising silica nanoparticles;
treating the composition to form a silica nanoparticle coating;
contacting the silica nanoparticle coating with a first polymer; and
removing the second polymer to form the construction.

10. The method of claim 9, wherein the composition comprises:
(a) 0.5 to 99 wt % water,
(b) 0.1 to 20 wt % silica nanoparticles having an average particle diameter of 40 nm or less,
(c) 0 to 20 wt % silica nanoparticles having an average particle diameter of 50 nm or more, wherein the sum of (b) and (c) is 0.1 to 20 wt %,
(d) a sufficient amount of an acid having a pKa of <3.5 to reduce the pH to less than 5, and
(e) 0 to 20 wt % of a tetraalkoxysilane, relative to the amount of the silica nanoparticles.

11. The construction of claim 1, wherein the silica nanoparticles in the plurality silica nanoparticles have an average primary particle size of 200 nm or less.

12. The construction of claim 1, wherein the undercoat layer is substantially uniform in thickness.

13. The construction of claim 1, wherein the undercoat layer is discontinuous.

14. The method of claim 9, wherein the first polymer is selected from at least one of: a polyurethane, polyesters, (meth)acrylic acid ester polymers, an epoxy, a (meth)acrylate, polyvinylchloride polymer, polyvinyl acetate polymer, polyamides, a urethane/(meth)acrylate, a silicone, a polyolefin, a fluoropolymer, acrylobutadiene polymers, and blends thereof.

15. The method of claim 9, wherein the second polymer is selected from at least one of a polyolefin, organic wax, and combinations thereof.

16. The method of claim 9, wherein the microspheres in the plurality of microspheres have an average diameter of 10 to 1000 micrometers.

17. The method of claim 9, the silica nanoparticles have an average primary particle size of 200 nm or less.

18. The method of claim 9, wherein the composition comprises an aqueous dispersion of silica nanoparticles; having a pH of less than 5, and an acid having a pKa of <3.5.

19. The method of claim 9, wherein the concentration of silica nanoparticles in the composition is 0.1 to 20 wt %.

20. The method of claim 9, further comprising adding sufficient acid to adjust the pH of the composition to less than 5, then adding sufficient base to adjust the pH to the range of 5 to 6.
